(19) United States
(12) Patent Application Publication
(10) Pub. No.: US 2017/0085492 A1
(43) Pub. Date: Mar. 23, 2017

(54) PACKET DATA CONVERGENCE PROTOCOL (PDCP) ENTITY AND METHOD PERFORMED BY THE SAME

(71) Applicants: Fangying XIAO, Shanghai (CN); SHARP KABUSHIKI KAISHA, Sakai City, Osaka (JP)

(72) Inventors: Fangying XIAO, Shanghai (CN); Renmao LIU, Shanghai (CN)

(73) Assignee: SHARP KABUSHIKI KAISHA, Sakai City, Osaka (JP)

(21) Appl. No.: 15/126,481

(22) PCT Filed: Mar. 4, 2015
(86) PCT No.: PCT/CN2015/073625

§ 371 Date: Sep. 15, 2016

(30) Foreign Application Priority Data
Mar. 19, 2014 (CN) 201410103924.4

(51) Int. Cl. H04L 12/801; H04L 1/18

(52) U.S. Cl. CPC H04L 47/34; H04L 1/1874

(57) ABSTRACT

The present disclosure provides a method performed by a Packet Data Convergence Protocol (PDCP) entity and the PDCP entity. The method comprises: mapping one or more PDCP Protocol Data Units (PDUs) received out-of-order from a lower layer entity of the PDCP entity to one or more PDCP Service Data Units (SDUs) and storing the PDCP SDUs in a reordering buffer; determining whether sequence numbers of one or more missing PDCP SDUs are smaller than the smaller one of the two maximum sequence numbers among PDCP SDUs received by the PDCP entity from two lower layer entities, respectively; and delivering one or more PDCP SDUs having sequence numbers smaller than the sequence numbers of the missing PDCP SDUs and one or more PDCP SDUs having sequence numbers larger than and consecutive with the sequence numbers of the missing PDCP SDUs, as stored in the reordering buffer, to a higher layer entity of the PDCP entity when the sequence numbers of the missing PDCP SDUs are smaller than the smaller of the maximum sequence numbers.

### TECHNICAL FIELD

The present disclosure relates to mobile communications, and more particularly, to a Packet Data Convergence Protocol (PDCP) entity and a method performed by the PDCP entity, for enabling a PDCP entity at a receiving side to deliver PDCP Service Data Units (SDUs) that are received out of order to a higher layer as early as possible.

### BACKGROUND

The user plane protocol stack at Layer 2 in the 3^{rd} Generation Partnership Project (3GPP) Long Term Evolution (LTE) system consists of three sub-layers. They are, from high to low: Packet Data Convergence Protocol (PDCP) layer, Radio Link Control (RLC) layer and Media Access Control (MAC) layer. At a transmitting side, traffic is provided to a particular layer by receiving Service Data Units (SDUs) from a higher layer and Protocol Data Units (PDUs) are outputted to a lower layer. For example, the RLC layer receives packets from the PDCP layer. These packets are PDCP PDUs for the PDCP layer, but also RLC SDUs for the RLC layer. An inverse process occurs at the receiving side. That is, each layer sends SDUs to a higher layer, which receives them as PDUs. The PDCP entity that receives PDCP PDUs is referred to as a PDCP Rx and the RLC entity that receives RLC PDUs is referred to as RLC Rx. Each PDCP SDU is identified by a PDCP sequence number (SN). Each PDCP SDU has the same SN as its corresponding PDCP PDU and RLC SDU. Each RLC PDU is identified by an RLC SN. The PDCP SNs and the RLC SNs can be reused in a round robin manner. When the PDCP SN reaches its maximum value, the next PDCP SN is numbered as the minimum value, with a corresponding Hyper Frame Number (HFN) incremented by 1. The PDCP SN and the HFN are combined into COUNT that uniquely identifies a PDCP SDU.

In 3GPP LTE Release 11, each radio bearer has a PDCP entity and an RLC entity. Each Base Station (BS), or NodeB or evolved NodeB (eNB), and each User Equipment (UE) has a MAC entity. Here, the UE can be a user terminal, a user node, a mobile terminal or a tablet computer. The functions at the RLC layer are implemented by an RLC entity, which can be configured as one of the following three data transmission modes: (1) Transparent Mode (TM), (2) Acknowledged Mode (AM), and Unacknowledged Mode (UM). In the AM RLC and the UM RLC modes, the RLC entity is responsible for transmitting and receiving RLC SDUs in order. In particular, at an RLC transmitter, an RLC entity in a BS or a UE sequentially divides RLC SDUs received from a PDCP entity into segments based on a size indicated by the MAC layer and adds respective RLC headers to form RLC PDUs for transmission in sequence. Each RLC header contains an RLC SN allocated to the RLC PDU. At an RLC receiver, an RLC entity receives RLC PDUs from a lower layer, re-orders and re-concatenates the RLC PDUs in an ascending order of RLC SNs, and delivers the re-concatenated RLC SDUs to the PDCP layer in an ascending order of SNs.

The 3GPP LTE Release 12, which is currently being developed, involves standardization for dual connectivity enabled UE, Master eNB (MeNB) and Secondary eNB (SeNB). A MeNB maintains Radio Resource Management (RRM) measurement configurations for a UE, and requests a SeNB for additional resources for the UE based on a received measurement report, a traffic condition or a bearer type. Upon receiving the request from the MeNB, the SeNB either configures a serving cell for the UE, or rejects the request due to lack of sufficient resources.

Based on different schemes for bearer split and the user plane protocol stack, in 3GPP TSG-RAN2 Meeting 83bis, two user plane architectures, 1A and 3C, have been determined as standardization options for the dual connectivity deployment. As shown in FIG. 1, the option 3C has the following features: (1) the MeNB communicates with a Serving Gateway (S-GW) via an S1-U interface; (2) the bearer split occurs in the MeNB; and (3) for a split bearer, its corresponding RLC entity exists in both the MeNB and the SeNB. In the option 3C, the RLC entity at the SeNB interacts with a higher layer (i.e., a PDCP entity at the MeNB) via an Xn interface (which includes an X2 interface). With the above features, in the dual connectivity deployment 3C, there are two categories of serving cells configured for a UE: (1) a Master Cell Group (MCG) consisting of serving cells of the MeNB, and (2) a Secondary Cell Group (SCG) consisting of serving cells of the SeNB. Accordingly, a dual connectivity enabled UE provides one PDCP entity and two RLC entities for a split bearer. The PDCP entity corresponds to the PDCP entity in the MCG. One of the two RLC entities corresponds to the RLC entity in the MCG and the other one corresponds to the RLC entity in the SCG.

In 3GPP LTE Release 11, since each PDCP Rx corresponds to only one RLC Rx, a reordering function in the RLC Rx ensures that the PDCP Rx can receive PDCP PDUs from the RLC layer in order. However, in the dual connectivity deployment with a split bearer, one PDCP Rx corresponds to two RLC Rxs and thus the PDCP PDUs the PDCP Rx receives from the two RLC Rxs are out of order. Hence, the PDCP Rx needs to reorder the PDCP PDUs from the two RLC Rxs. In 3GPP TSG RAN WG2 Meeting #85, it has been proposed that the PDCP reordering function will use a reordering scheme based on a t-Reordering timer, similar to the scheme used in UM RLC. The basic concept of this scheme is as follows. The PDCP Rx receives PDCP PDUs from two RLC Rxs. When a PDCP PDU is received out of order, it can be stored in a reordering buffer and a t-Reordering timer can be started, waiting for the arrival of the missing PDCP PDUs. When the missing PDCP PDUs are received, the PDCP PDUs that have been received in order will be delivered to the higher layer. However, when a PDCP SDU is discarded in the PDCP Tx due to expiration of a discard timer or is lost during transmission over X2 interface, the PDCP PDUs that are received out of order will be stored in the reordering buffer and will not be delivered to the higher layer until the t-Reordering timer expires. This will increase the latency of PDCP SDUs and delay the TCP traffic control function. When the t-Reordering timer is set to a large value, the PDCP PDUs that are received out of order will become obsolete as being stored in the reordering buffer, waiting for the discarded or lost PDCP PDUs, resulting in a degraded transmission delay and reliability over a radio link.

### SUMMARY

In order to solve the above problem, the present disclosure provides a mechanism allowing a PDCP entity at a receiving side to deliver PDCP SDUs that are received out of order to a higher layer as early as possible.

In order to achieve the above object, according to a first aspect of the present disclosure, a method performed by a Packet Data Convergence Protocol (PDCP) entity at a receiving side is provided. The method comprises: mapping one or more PDCP Protocol Data Units (PDUs) received out-of-order from a lower layer entity of the PDCP entity to one or more PDCP Service Data Units (SDUs) and storing the PDCP SDUs in a reordering buffer; determining whether sequence numbers of one or more missing PDCP SDUs are smaller than the smaller one of the two maximum sequence numbers among PDCP SDUs received by the PDCP entity from two lower layer entities, respectively; and delivering one or more PDCP SDUs having sequence numbers smaller than the sequence numbers of the missing PDCP SDUs and one or more PDCP SDUs having sequence numbers larger than and consecutive with the sequence numbers of the missing PDCP SDUs, as stored in the reordering buffer, to a higher layer entity of the PDCP entity when the sequence numbers of the missing PDCP SDUs are smaller than the smaller of the maximum sequence numbers.

In the method according to the first aspect of the present disclosure, it can be determined whether the sequence numbers of the missing PDCP SDUs are smaller than the smaller of the maximum sequence numbers in a descending order of the sequence numbers of the missing PDCP SDUs. Once the sequence number of one of the missing PDCP SDUs is determined to be smaller than the smaller of the maximum sequence numbers, any determination as to whether the sequence numbers of the remaining missing PDCP SDUs are smaller than the smaller of the maximum sequence numbers can be omitted.

In order to achieve the above object, according to a second aspect of the present disclosure, another method performed by a Packet Data Convergence Protocol (PDCP) entity at a receiving side is provided. The method comprises: mapping one or more PDCP Protocol Data Units (PDUs) received out-of-order from a lower layer entity of the PDCP entity to one or more PDCP Service Data Units (SDUs) and storing the PDCP SDUs in a reordering buffer; and delivering one or more PDCP SDUs stored in the reordering buffer that have sequence numbers smaller than or equal to a smaller of maximum sequence numbers among PDCP SDUs received by the PDCP entity from two lower layer entities, respectively, and their subsequent, consecutive PDCP SDUs, to a higher layer entity of the PDCP entity.

In the method according to the second aspect of the present disclosure, the step of delivering one or more PDCP SDUs stored in the reordering buffer that have sequence numbers smaller than or equal to the smaller one of the two maximum sequence numbers among PDCP SDUs received by the PDCP entity from two lower layer entities, respectively, and their subsequent, consecutive PDCP SDUs, to the higher layer entity of the PDCP entity comprises: determining whether the sequence numbers of the PDCP SDUs stored in the reordering buffer are smaller than or equal to the smaller one of the two maximum sequence numbers in a descending order of the sequence numbers of the PDCP SDUs stored in the reordering buffer, wherein, once the sequence number of one of the PDCP SDUs is determined to be smaller than or equal to the smaller one of the two maximum sequence numbers, any determination as to whether the sequence numbers of the remaining PDCP SDUs are smaller than or equal to the smaller one of the two maximum sequence numbers is omitted and the remaining PDCP SDUs, the PDCP SDU having the sequence number determined to be smaller than or equal to the smaller one of the two maximum sequence numbers and its subsequent, consecutive PDCP SDUs are delivered to the higher layer entity of the PDCP entity.

According to a third aspect of the present disclosure, a method performed by a Packet Data Convergence Protocol (PDCP) entity at a transmitting side is provided. The method comprises: discarding one or more PDCP Service Data Units (SDUs) each having an associated discard timer expired; and transmitting to a PDCP entity at a receiving side a PDCP control Protocol Data Unit (PDU) indicating all or part of the expired PDCP SDUs.

In the method according to the third aspect of the present disclosure, the PDCP control PDU may indicate an expired PDCP SDU having a maximum sequence number among the expired PDCP SDUs and satisfying a condition that all PDCP SDUs having sequence numbers smaller than that of the expired PDCP SDU have expired or have been acknowledged to be successfully transmitted. Alternatively, the PDCP control PDU may indicate the expired PDCP SDUs satisfying a condition that the sequence numbers of the expired PDCP SDUs are larger than a smaller of maximum sequence numbers among PDCP SDUs that have been acknowledged by two lower layer entities of the PDCP entity at the transmitting side, respectively, to be successfully transmitted. The PDCP control PDU may contain a plurality of fields, one of which indicates the expired PDCP SDUs in form of sequence numbers or a bitmap.

The present disclosure also provides PDCP entities corresponding to the methods according to the first, second and third aspects, respectively.

With the solutions of the present disclosure, after a PDCP receiving entity receives PDCP SDUs from a PDCP transmitting entity, the PDCP SDUs can be delivered to the higher layer as early as possible, thereby reducing radio link delay and improving radio link reliability.

### BRIEF DESCRIPTION OF THE DRAWINGS

The above and other objects, features and advantages will be more apparent from the following description of embodiments with reference to the figures, in which:

FIG. 1 is a schematic diagram showing an option 3C for dual connectivity deployment as specified in 3GPP TR 36.842;

FIG. 2 is a flowchart illustrating a method for a receiving PDCP entity to deliver PDCP SDUs that are received out of order to a higher layer as early as possible according to a first aspect of the present disclosure;

FIG. 3 is a flowchart illustrating an exemplary embodiment of the method according to the first aspect of the present disclosure;

FIG. 4 is a flowchart illustrating another exemplary embodiment of the method according to the first aspect of the present disclosure;

FIG. 5 is a flowchart illustrating a method for a receiving PDCP entity to deliver PDCP SDUs that are received out of order to a higher layer as early as possible according to a second aspect of the present disclosure;

FIG. 6 is a flowchart illustrating a method performed by a PDCP transmitting entity for facilitating a receiving PDCP entity to deliver PDCP SDUs that are received out of order to a higher layer as early as possible according to a third aspect of the present disclosure;

FIG. 7 is a schematic diagram showing a PDCP control PDU used in the method according to the third aspect of the present disclosure;

FIG. 8 is a schematic diagram showing a state of a buffer at a PDCP transmitting entity;

FIG. 9 is a flowchart illustrating a method for a PDCP transmitting entity to determine whether to report discard of PDCP SDUs to a PDCP receiving entity in an exemplary embodiment of the method according to the third aspect of the present disclosure;

FIG. 10 is a block diagram showing a structure of a PDCP entity for performing the method according to the first aspect of the present disclosure;

FIG. 11 is a block diagram showing a structure of a PDCP entity for performing the method according to the second aspect of the present disclosure; and

FIG. 12 is a block diagram showing a structure of a PDCP entity for performing the method according to the third aspect of the present disclosure.

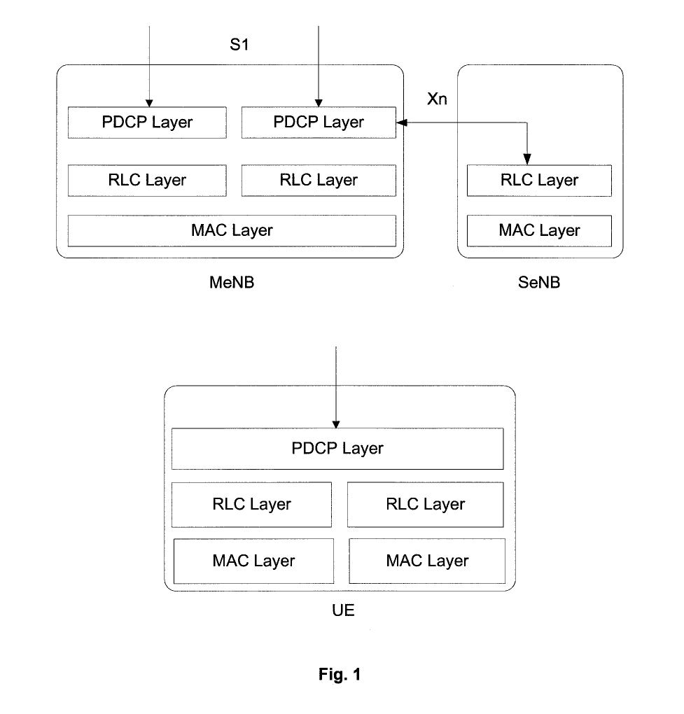

### DETAILED DESCRIPTION

The principles and implementations of the present disclosure will become more apparent from the following description of the embodiments taken in conjunction with the drawings. It should be noted that the following embodiments are illustrative only, rather than limiting the scope of the present disclosure. In the following description, details of well known techniques which are not directly relevant to the present invention will be omitted so as not to obscure the concept of the invention.

In the following, a number of embodiments of the present invention will be detailed in an exemplary application environment of LTE Release 12 mobile communication system and its subsequent evolutions. Herein, it is to be noted that the present invention is not limited to the application exemplified in the embodiments. Rather, it is applicable to other communication systems, such as the future 5G cellular communication system.

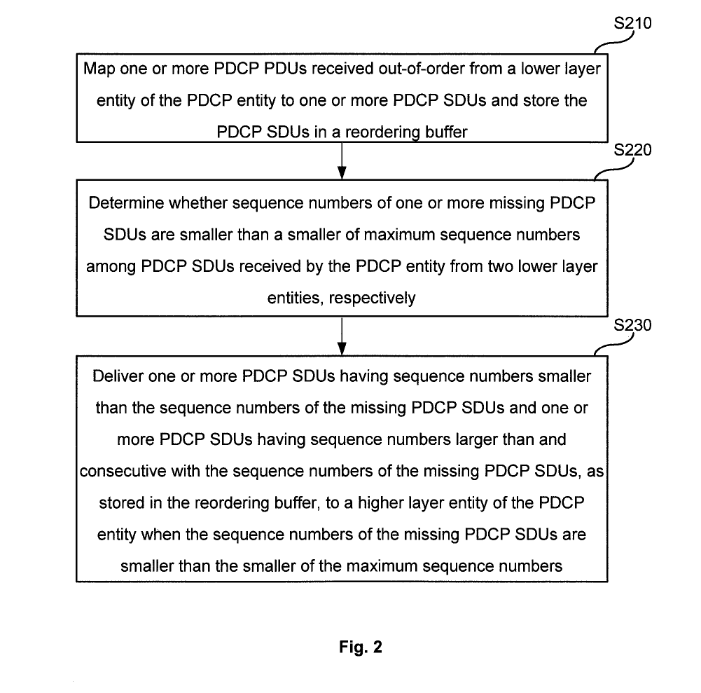

First, a method for a receiving PDCP entity to deliver PDCP SDUs that are received out of order to a higher layer as early as possible according to a first aspect of the present disclosure will be described with reference to FIG. 2. As shown, the method starts with step S210 where the PDCP entity maps one or more PDCP PDUs received out-of-order from a lower layer entity of the PDCP entity to one or more PDCP SDUs and stores the PDCP SDUs in a reordering buffer. Next, at step S220, the PDCP entity determines whether sequence numbers of one or more missing PDCP SDUs are smaller than the smaller one of the two maximum sequence numbers among PDCP SDUs received by the PDCP entity from two lower layer entities, respectively. Then, at step S230, the PDCP entity delivers one or more PDCP SDUs having sequence numbers smaller than the sequence numbers of the missing PDCP SDUs and one or more PDCP SDUs having sequence numbers larger than and consecutive with the sequence numbers of the missing PDCP SDUs, as stored in the reordering buffer, to a higher layer entity of the PDCP entity when the sequence numbers of the missing PDCP SDUs are smaller than the smaller of the maximum sequence numbers.

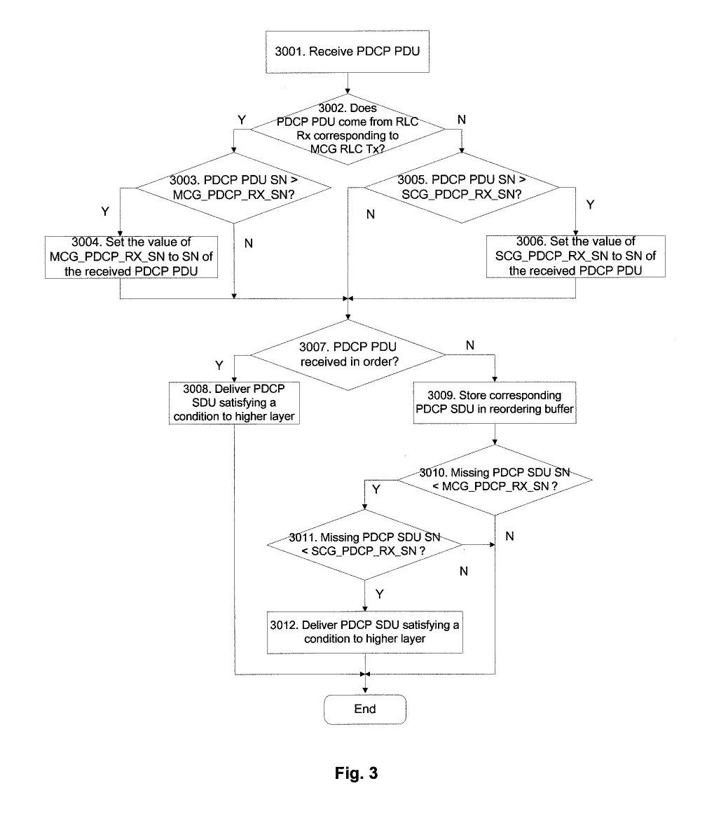

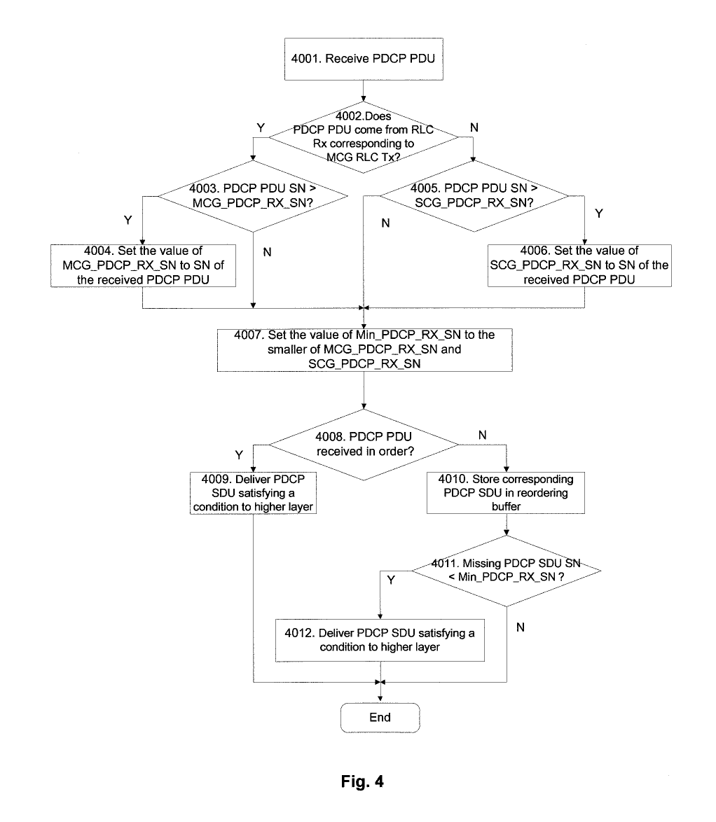

FIG. 3 and FIG. 4 further show flowcharts of two specific implementations of the above methods, respectively. For simplicity, in the embodiments of the present disclosure, only operations performed by a UE as a receiver and operations performed by an MCG as a transmitter in a downlink will be described. However, it can be appreciated by those skilled in the art that the above process also applies to an uplink communication process, i.e., to operations performed by an MCG as a receiver and a UE as a transmitter, without departing from the spirit and scope of the present disclosure.

In the embodiment shown in FIG. 3, the PDCP entity corresponding to a split bearer in the UE maintains three state variables, Next_PDCP_RX_SN, MCG_PDCP_RX_SN and SCG_PDCP_RX_SN. The state variable Next_PDCP_RX_SN indicates the sequence number of the next PDCP SDU desired to be received and has an initial value of 0. Each time the PDCP entity delivers PDCP SDUs to the higher layer, Next_PDCP_RX_SN will be updated to the maximum sequence number among the PDCP SDUs delivered to the higher layer plus 1. The state variable MCG_PDCP_RX_SN indicates the maximum sequence number among PDCP SDUs received from an RLC Rx corresponding to an MCG RLC Tx and has an initial value of 0. When a PDCP SDU having a sequence number larger than MCG_PDCP_RX_SN is received from the RLC Rx corresponding to the MCG RLC Tx, MCG_PDCP_RX_SN is set to the sequence number of the received PDCP SDU. The state variable SCG_PDCP_RX_SN indicates a maximum sequence number among PDCP SDUs received from an RLC entity corresponding to an SCG RLC Tx and has an initial value of 0. When a PDCP SDU having a sequence number larger than SCG_PDCP_RXSN is received from the RLC Rx corresponding to the SCG RLC Tx, SCG_PDCP_RX_SN is set to the sequence number of the received PDCP SDU. It is to be noted that, in the context of this and the other embodiments described hereinafter, a comparison between sequence numbers refers to a comparison between respective COUNT values corresponding to the sequence numbers, and an addition/subtraction operation of a sequence number refers to an addition/subtraction operation of a COUNT value corresponding to the sequence number.

As shown in FIG. 3, at step 3001, the PDCP entity receives a PDCP PDU from a lower layer. The PDCP entity here refers to a PDCP entity corresponding to a split bearer in the UE. For simplicity, the PDCP entity in the subsequent steps refers to the PDCP entity corresponding to the split bearer in the UE, unless indicated otherwise.

At step 3002, the PDCP entity determines whether the received PDCP PDU comes from an RLC Rx corresponding to an MCG RLC Tx or an RLC Rx corresponding to an SCG RLC Tx. If the PDCP SDU comes from the RLC Rx corresponding to the MCG RLC Tx, the method proceeds with step 3003. If the PDCP SDU comes from the RLC Rx corresponding to the SCG RLC Tx, the method proceeds with step 3005.

At step 3003, the PDCP entity determines whether the PDCP PDU has a sequence number larger than the state variable MCG_PDCP_RX_SN. If so, the method proceeds with step 3004; otherwise the method proceeds with step 3007.

At step 3004, the PDCP entity sets the value of the state variable MCG_PDCP_RX_SN to the sequence number of the PDCP PDU.

At step 3005, the PDCP entity determines whether the PDCP PDU has a sequence number larger than the state variable SCG_PDCP_RX_SN. If so, the method proceeds with step 3006; otherwise the method proceeds with step 3007.

At step 3006, the PDCP entity sets the value of the state variable SCG_PDCP_RX_SN to the sequence number of the PDCP PDU.

At step 3007, the PDCP entity determines whether the PDCP PDU is received in order. If so, the method proceeds with step 3008; otherwise the method proceeds with step 3009. The PDCP PDU being received in order means that the sequence number of the PDCP PDU is the minimum sequence number among PDCP SDUs desired to be received (or missing), i.e., Next_PDCP_RX_SN. For example, assuming that the maximum sequence number among PDCP SDUs the PDCP entity has delivered to the higher layer is 4 and the PDCP PDUs that have been received out of order and stored in a PDCP reordering buffer have sequence numbers of 6, 7 and 9, respectively, the PDCP PDU is received in order if it has a sequence number of 5. On the other hand, the PDCP PDU is not received in order if it has a sequence number of 8.

At step 3008, the PDCP entity removes the header of the PDCP PDU and, after decryption and IP header decompression, maps it to a PDCP SDU. Then, the PDCP SDU and its subsequent, consecutive PDCP SDUs are delivered to the higher layer. The PDCP entity updates Next_PDCP_RX_SN to the maximum sequence number among the PDCP SDUs delivered to the higher layer plus 1. For example, in the example described in connection with the step 3007, if the PDCP PDU received by the PDCP entity has a sequence number of 5, the PDCP entity maps, after decryption and IP header decompression, the PDCP PDU having the sequence number of 5 to a PDCP SDU having a sequence number of 5, and then delivers the PDCP SDUs having the sequence numbers of 5, 6 and 7 to the higher layer sequentially and set the value of Next_PDCP_RX_SN to 8.

Optionally, the PDCP entity updates the smaller of MCG_PDCP_RX_SN and SCG_PDCP_RX_SN to the maximum sequence number among the PDCP SDUs delivered to the higher layer plus 1. In this case, the variable Next_PDCP_RX_SN can be omitted and, in the step 3007, it can be determined whether the PDCP PDU is received in order by comparing the sequence number of the received PDCP SDU with the smaller of MCG_PDCP_RX_SN and SCG_PDCP_RX_SN.

At step 3009, the PDCP entity removes the header of the PDCP PDU and, after decryption and IP header decompression, maps it to a PDCP SDU and stores it in the reordering buffer.

At step 3010, the PDCP entity determines whether the sequence numbers of the missing PDCP SDUs are smaller than the state variable MCG_PDCP_RX_SN. If the sequence numbers of the missing PDCP SDUs are smaller than the state variable MCG_PDCP_RX_SN, the method proceeds with step 3011; otherwise the method ends. The missing PDCP SDUs refer to PDCP SDUs desired to be received. For example, in the example described in connection with the step 3007, if the received PDCP PDU has a sequence number of 8, the missing PDCP SDU has a sequence number of 5.

At step 3011, the PDCP entity determines whether the sequence numbers of the missing PDCP SDUs are smaller than the state variable SCG_PDCP_RX_SN. If the sequence numbers of the missing PDCP SDUs are smaller than the state variable SCG_PDCP_RX_SN, the method proceeds with step 3012; otherwise the method ends.

At step 3012, the PDCP entity delivers all PDCP SDUs having sequence numbers smaller than the sequence numbers of the missing PDCP SDUs and the consecutive PDCP SDUs following the missing PDCP SDUs, as stored in the reordering buffer, to the higher layer. Meanwhile, the PDCP entity updates Next_PDCP_RX_SN to the maximum sequence number among the PDCP SDUs delivered to the higher layer plus 1. For example, assuming that the maximum sequence number among the PDCP SDUs the PDCP entity has delivered to the higher layer is 4 and the sequence numbers of the PDCP SDUs that are received out of order and stored in the PDCP reordering buffer are 6, 9 and 12, MCG_PDCP_RX_SN is 4 and SCG_PDCP_RX_SN is 12. After a PDCP SDU having a sequence number of 10 is received from the MCG, the sequence numbers of the PDCP SDUs that are received out of order and stored in the PDCP reordering buffer are 6, 9, 10 and 12, MCG_PDCP_RX_SN is 10 and SCG_PDCP_RX_SN is 12. The sequence numbers of the missing PDCP SDUs are 5, 7, 8 and 11. The step 3010 is performed in a descending order and the subsequent steps are performed based on the determination result. First, the step 3010 is performed for the PDCP SDU having the sequence number of 11, but it does not satisfy the condition set in the step 3010. Then, the steps 3010 and 3011 are performed for the PDCP SDU having the sequence number of 8, which satisfies the conditions set in the steps 3010 and 3011. In the step 3012, any PDCP SDU received out of order and stored in the PDCP reordering buffer and having a sequence number smaller than that of the missing PDCP SDU, i.e., the PDCP SDU having the sequence number of 6, is delivered to the higher layer. In addition, the PDCP SDUs having sequence numbers consecutive with the sequence number, 8, of the missing PDCP SDU, i.e., the PDCP SDUs having the sequence numbers of 9 and 10, are delivered to the higher layer, and the value of Next_PDCP_RX_SN is updated to 10. However, the PDCP SDU having the sequence number of 12 is still stored in the reordering buffer.

Alternatively, the variable Next_PDCP_RX_SN can be omitted and the PDCP entity can update the smaller of MCG_PDCP_RX_SN and SCG_PDCP_RX_SN to the maximum sequence number among the PDCP SDUs delivered to the higher layer plus 1.

It is to be noted here that the steps 3002-3006 and the step 3007 can be performed in a different order. That is, the step 3007 can be performed first and, if the determination result is no, the method proceeds with the step 3002-3006 and then the step 3009 and the subsequent steps. The sequence of the steps 3010 and 3011 can also be changed. In addition, if there is more than one missing PDCP SDU, the steps 3010 and 3011 need to be performed for each of the missing PDCP SDUs. For example, the missing PDCP SDUs can be handled in a descending or ascending order of the sequence numbers. If they are handled in a descending order, when a missing PDCP SDU satisfies both the steps 3010 and 3011, the PDCP entity can determine that the missing PDCP SDUs having sequence numbers smaller than the sequence number of that PDCP SDU have been lost. Hence, it is not necessary to perform the steps 3010, 3011 and the subsequent steps dependent on the determination result for the missing PDCP SDUs having sequence numbers smaller than the sequence number of that PDCP SDU.

In the embodiment shown in FIG. 4, the PDCP entity corresponding to a split bearer in the UE further maintains a state variable Min_PDCP_RX_SN, in addition to the state variables MCG_PDCP_RX_SN and SCG_PDCP_RX_SN. The value of the state variable Min_PDCP_RX_SN is set to the smaller of MCG_PDCP_RX_SN and SCG_PDCP_RX_SN and is updated each time MCG_PDCP_RX_SN or SCG_PDCP_RX_SN is updated. Min_PDCP_RX_SN has an initial value of 0. It is to be noted here that, a comparison between sequence numbers refers to a comparison between respective COUNT values corresponding to the sequence numbers.

The step 4001 is the same as the step 3001 and the description thereof will be omitted here.

The step 4002 is the same as the step 3002 and the description thereof will be omitted here.

The step 4003 is the same as the step 3003 and the description thereof will be omitted here.

The step 4004 is the same as the step 3004 and the description thereof will be omitted here.

The step 4005 is the same as the step 3005 and the description thereof will be omitted here.

The step 4006 is the same as the step 3006 and the description thereof will be omitted here.

At step 4007, The value of the state variable Min_PDCP_RX_SN is set to the smaller of MCG_PDCP_RX_SN and SCG_PDCP_RX_SN.

The step 4008 is the same as the step 3007 and the description thereof will be omitted here.

The step 4009 is the same as the step 3008 and the description thereof will be omitted here.

The step 4010 is the same as the step 3009 and the description thereof will be omitted here.

At step 4011, the PDCP entity determines whether the sequence numbers of the missing PDCP SDUs are smaller than the state variable Min_PDCP_RX_SN. If the sequence numbers of the missing PDCP SDUs are smaller than the state variable Min_PDCP_RX_SN, the method proceeds with step 4012; otherwise the method ends.

The step 4012 is the same as the step 3012 and the description thereof will be omitted here.

It is to be noted here that the steps 4002-4007 and the step 4008 can be performed in a different order. That is, the step 4008 can be performed first and, if the determination result is no, the method proceeds with the step 4002-4007 and then the step 4010 and the subsequent steps. In addition, if there is more than one missing PDCP SDU in the step 4012, the step 4011 needs to be performed for each of the missing PDCP SDUs. For example, the missing PDCP SDUs can be handled in a descending or ascending order of the sequence numbers. If they are handled in a descending order, when the step of 4011 is performed for a missing PDCP SDU, the PDCP entity can determine that the missing PDCP SDUs having sequence numbers smaller than the sequence number of that PDCP SDU have been lost. Hence, it is not necessary to perform the step 4011 and the subsequent steps dependent on the determination result for the missing PDCP SDUs having sequence numbers smaller than the sequence number of that PDCP SDU.

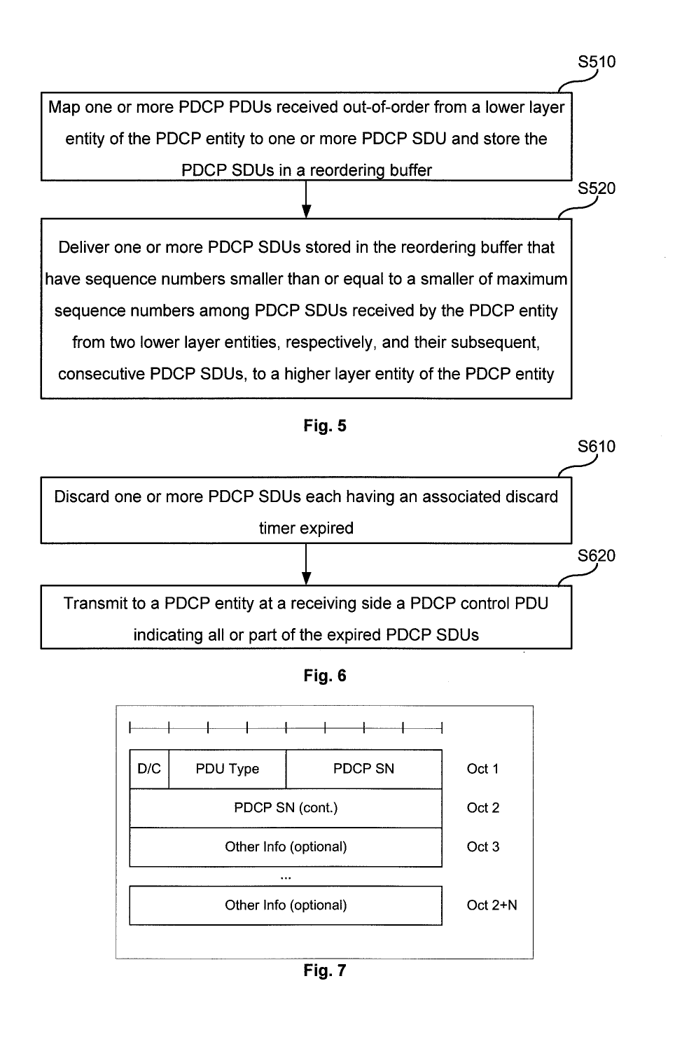

FIG. 5 is a flowchart illustrating a method for a receiving PDCP entity to deliver PDCP SDUs that are received out of order to a higher layer as early as possible according to a second aspect of the present disclosure. This method differs from the method shown in FIG. 2 mainly in that the former compares sequence numbers of PDCP SDUs received out-of-order and stored in the reordering buffer with the smaller of maximum sequence numbers among PDCP SDUs received by the PDCP entity from two lower layer entities, respectively, and the latter compares sequence numbers of missing PDCP SDUs with the smaller of maximum sequence numbers among PDCP SDUs received by the PDCP entity from two lower layer entities, respectively. For simplicity, in the embodiments of the present disclosure, only operations performed by a UE as a receiver and operations performed by an MCG as a transmitter in a downlink will be described. However, it can be appreciated by those skilled in the art that the above process also applies to an uplink communication process, i.e., to operations performed by an MCG as a receiver and a UE as a transmitter, without departing from the spirit and scope of the present disclosure.

As shown, the method starts with step S510 where the PDCP entity maps one or more PDCP Protocol Data Units (PDUs) received out-of-order from a lower layer entity of the PDCP entity to one or more PDCP SDUs and stores the PDCP SDUs in a reordering buffer.

As in the embodiments described above in connection with FIGS. 3 and 4, in an implementation, the PDCP entity corresponding to a split bearer in the UE can maintain and update two state variables, MCG_PDCP_RX_SN and SCG_PDCP_RX_SN. If the PDCP SDU received by the PDCP entity from the lower layer comes from an MCG and the PDCP PDU has a sequence number larger than MCG_PDCP_RX_SN, the value of MCG_PDCP_RX_SN is set to the sequence number of the PDCP PDU. If the PDCP SDU received by the PDCP entity from the lower layer comes from an SCG and the PDCP PDU has a sequence number larger than SCG_PDCP_RX_SN, the value of SCG_PDCP_RX_SN is set to the sequence number of the PDCP PDU. It is to be noted here that a comparison between sequence numbers refers to a comparison between respective COUNT values corresponding to the sequence numbers.

At step S520, the PDCP entity delivers one or more PDCP SDUs stored in the reordering buffer and received out-of-order that have sequence numbers smaller than or equal to the smaller of MCG_PDCP_RX_SN and SCG_PDCP_RX_SN and their subsequent, consecutive PDCP SDUs, to a higher layer.

In particular, the PDCP entity can compare the sequence numbers of the PDCP SDUs received out-of-order and stored in the PDCP reordering buffer individually with the smaller of the state variables MCG_PDCP_RX_SN and SCG_PDCP_RX_SN in an ascending or descending order of sequence numbers, and deliver the PDCP SDUs having sequence numbers smaller than or equal to the smaller of the state variables MCG_PDCP_RX_SN and SCG_PDCP_RX_SN and their subsequent, consecutive PDCP SDUs, to the higher layer. If the sequence numbers are compared with the smaller of the state variables MCG_PDCP_RX_SN and SCG_PDCP_RX_SN in a descending order of sequence numbers, when a PDCP SDU received out-of-order has a sequence number smaller than or equal to the smaller of the state variables MCG_PDCP_RX_SN and SCG_PDCP_RX_SN, the PDCP entity can determine that any PDCP SDU received out-of-order and having a sequence number smaller than that of the PDCP SDU necessarily has a sequence number smaller than the smaller of the state variables MCG_PDCP_RX_SN and SCG_PDCP_RX_SN. Hence, there is no need to compare the sequence number of any PDCP SDU received out-of-order and having a sequence number smaller than that of the PDCP SDU with the smaller of the state variables MCG_PDCP_RX_SN and SCG_PDCP_RX_SN.

For example, it is assumed that the maximum sequence number among PDCP SDUs that have been delivered by the PDCP entity to the higher layer is 4 and the PDCP SDUs received out-of-order and stored in the PDCP reordering buffer have sequence numbers of 6, 9, 10 and 12, respectively. In this case, MCG_PDCP_RX_SN is 4 and SCG_PDCP_RX_SN is 12. After the PDCP SDU having the sequence number of 8 has been received from the MCG, the PDCP entity updates MCG_PDCP_RX_SN to 8 and SCG_PDCP_RX_SN remains at 12. The PDCP SDUs received out-of-order and stored in the PDCP reordering buffer have sequence numbers of 6, 8, 9, 10 and 12, respectively. Then, since the PDCP SDU having the sequence number of 8 as stored in the reordering buffer also satisfies the condition that its sequence number is smaller than the smaller of the state variables MCG_PDCP_RX_SN and SCG_PDCP_RX_SN, the PDCP SDUs having sequence numbers smaller than or equal to 8 (SN=6, 8) and the PDCP SDUs having sequence numbers consecutive with 8 (SN=9, 10) are delivered to the higher layer. That is, the PDCP SDUs having the sequence numbers of 6, 8, 9 and 10, respectively, are delivered to the higher layer.

As in the embodiment described above in connection with FIG. 3, the PDCP entity can further maintain a state variable Next_PDCP_RX_SN for determining whether a received PDCP SDU is received in order. Optionally, the PDCP entity can further update the smaller of MCG_PDCP_RX_SN and SCG_PDCP_RX_SN to the maximum sequence number among the PDCP SDUs delivered to the higher layer plus 1. In this case, the variable Next_PDCP_RX_SN can be omitted and, it can be determined whether the PDCP PDU is received in order by comparing the sequence number of the received PDCP SDU with the smaller of MCG_PDCP_RX_SN and SCG_PDCP_RX_SN.

It is to be noted that, as in the embodiment described above in connection with FIG. 4, the PDCP receiving entity may maintain three state variables, MCG_PDCP_RX_SN, SCG_PDCP_RX_SN and Min_PDCP_RX_SN. In this case, at step S520, the PDCP entity compares the sequence numbers of the PDCP SDUs received out-of-order and stored in the reordering buffer with Min_PDCP_RX_SN. The PDCP SDUs received out-of-order, stored in the reordering buffer and having sequence numbers smaller than or equal to the state variable Min_PDCP_RX_SN and their subsequent, consecutive PDCP SDUs, to the higher layer.

In addition, in order to enable a PDCP receiving entity to deliver PDCP SDUs that are received out of order to the higher layer as early as possible, the present disclosure provides a method performed by the PDCP transmitting entity, as shown in FIG. 6. The method includes the following steps. At step S610, the PDCP transmitting entity discards one or more PDCP SDUs each having an associated discard timer expired. At step S620, the PDCP transmitting entity transmits to a PDCP receiving entity an indication message indicating that particular ones of the expired PDCP SDUs have been discarded. The indication message can be a newly defined PDCP control PDU. FIG. 7 shows a structure of the PDCP control PDU. The PDCP control PDU shown in FIG. 7 includes various fields as follows.

A D/C field indicates to the receiver whether the PDCP PDU is a PDCP control PDU or a PDCP data PDU. In this embodiment, it can be set to 0 to indicate that the PDCP PDU is a PDCP control PDU. A PDCP Type field indicates a type of the PDCP control PDU. In this embodiment, since the PDCP control PDU is newly defined, this Type field can be set to a value other than 000 and 001, e.g., 010. A PDCP SN field indicates a sequence number of an expired PDCP SDU that has been discarded. When there are more than one PDCP SDU has been discarded due to expiration, the sequence numbers of the discarded PDCP SDUs, or a bitmap generated based on the discarded PDCP SDUs, can be included in the PDCP control PDU. The above information can be described using other information fields. Other information fields are optional.

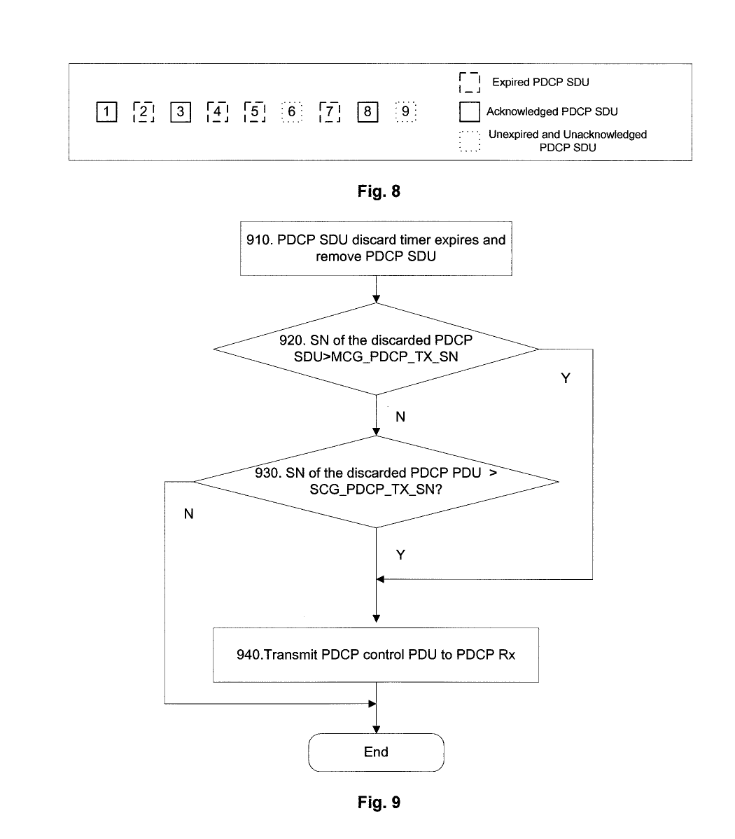

In order to prevent the PDCP Tx from transmitting any unnecessary PDCP control PDU to the PDCP Rx due to discard of the expired PDCP SDUs, the PDCP control PDU transmitted from the PDCP Tx to the PDCP Rx indicates an expired PDCP SDU having a maximum sequence number among the expired PDCP SDUs and satisfying a condition that all PDCP SDUs having sequence numbers smaller than that of the expired PDCP SDU have expired or have been acknowledged to be successfully transmitted. For example, in FIG. 8, there are PDCP SDUs having sequence numbers of 1, 2, 3, 4, 5, 6, 7, 8 and 9, respectively, in the PDCP Tx to be transmitted, among which the PDCP SDUs having the sequence numbers of 1, 2 and 8, respectively, have been acknowledged by the lower layer to be successfully transmitted, the PDCP SDUs having the sequence numbers of 2, 4, 5 and 7, respectively, have been discarded due to expiration, and the PDCP SDUs having the sequence numbers of 6 and 9, respectively have been transmitted but have not been acknowledged by the lower layer. Since, among the expired PDCP SDUs, the expired PDCP SDUs having the sequence numbers of 2, 4 and 5, respectively, satisfy the condition (that all PDCP SDUs having sequence numbers smaller than that of the expired PDCP SDU have expired or have been acknowledged to be successfully transmitted), with the sequence number of 5 being maximum among them, the PDCP control PDCU transmitted by the PDCT Tx to the PDCP Rx contains a sequence number of 5. Upon receiving the PDCP control PDU, the PDCP Rx can determine that the missing PDCP SDUs having sequence numbers equal to or smaller than 5 have expired and deliver the PDCP SDU having the sequence number of 3 as stored in the reordering buffer to the higher layer.

In an alternative embodiment in which a PDCP Tx transmits to a PDCP receiving entity a PDCP control PDU indicating that particular PDCP SDUs have been discarded, the transmitted PDCP control PDU indicates the expired PDCP SDUs satisfying a condition that the sequence numbers of the expired PDCP SDUs are larger than a smaller of maximum sequence numbers among PDCP SDUs that have been acknowledged by two lower layer entities of the PDCP entity at the transmitting side, respectively, to be successfully transmitted. In this case, the PDCP Tx can maintain two state variables, MCG_PDCP_TX_SN and SCG_PDCP_TX_SN. The state variable MCG_PDCP_TX_SN indicates a maximum sequence number among PDCP SDUs that have been reported by an MCG RLC Tx to be successfully transmitted and has an initial value of 0. When the MCG RLC Tx acknowledges that a PDCP PDU having a sequence number larger than MCG_PDCP_TX_SN has been successfully transmitted, MCG_PDCP_TX_SN is set to the sequence number of the acknowledged PDCP SDU. The state variable SCG_PDCP_TX_SN indicates a maximum sequence number among PDCP SDUs that have been acknowledged by an SCG RLC Tx to be successfully transmitted and has an initial value of 0. When the SCG RLC Tx acknowledges that a PDCP PDU having a sequence number larger than SCG_PDCP_TX_SN has been successfully transmitted, SCG_PDCP_TX_SN is set to the sequence number of the acknowledged PDCP SDU. It is to be noted that a comparison between sequence numbers refers to a comparison between respective COUNT values corresponding to the sequence numbers.

As shown in the flowchart of FIG. 9, at step 910, the PDCP Tx detects that a discard timer associated with a PDCP SDU has expired and discards the PDCP SDU.

At step 920, the PDCP Tx determines whether the sequence number of the discarded PDCP SDU is larger than MCG_PDCP_TX_SN. If so, the method proceeds with step 940; otherwise the method proceeds with step 930.

At step 930, the PDCP Tx determines whether the sequence number of the discarded PDCP SDU is larger than SCG_PDCP_TX_SN. If so, the method proceeds with step 940; otherwise the method ends.

At step 940, the PDCP Tx generates a PDCP control PDU based on the discarded PDCP SDU and transmits it to the PDCP Rx.

It is to be noted that the steps 920 and 930 can be performed in a different order. In addition, the steps 920 and 930 can be combined. That is, if the sequence number of the discarded PDCP SDU is larger than the smaller of the maximum sequence number among PDCP SDUs acknowledged by the MCG RLC Tx and the maximum sequence number among PDCP SDUs acknowledged by the SCG RLC Tx, the discarded PDCP SDU needs to be reported to the PDCP Rx. In this case, the PDCP Tx needs to maintain a state variable Min_PDCP_TX_SN, in addition to the state variables MCG_PDCP_TX_SN and SCG_PDCP_TX_SN. The value of the state variable Min_PDCP_TX_SN is set to the smaller of MCG_PDCP_TX_SN and SCG_PDCP_TX_SN. Each time MCG_PDCP_TX_SN or SCG_PDCP_TX_SN is updated, Min_PDCP_TX_SN is updated accordingly. Min_PDCP_TX_SN has an initial value of 0. If the sequence number of the PDCP SDU having the discard timer expired is larger than Min_PDCP_TX_SN, the sequence number of the expired PDCP SDU is included in the PDCP control PDU transmitted to the PDCP Rx.

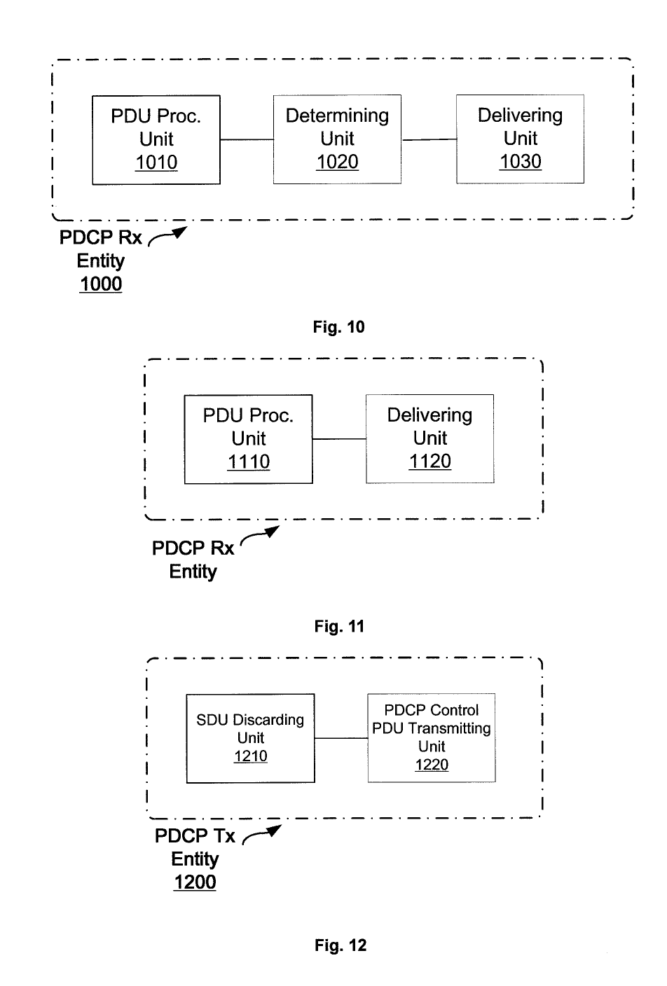

Correspondingly to the method according to the first aspect of the present disclosure, a corresponding PDCP entity 1000 is also provided. FIG. 10 is a block diagram showing a structure of a PDCP entity 1000.

As shown, the PDCP entity 1000 includes a PDCP processing unit 1010, a determining unit 1020 and a delivering unit 1030. The PDU processing unit 1010 is configured to map one or more PDCP Protocol Data Units (PDUs) received out-of-order from a lower layer entity of the PDCP entity to one or more PDCP Service Data Units (SDUs) and store the PDCP SDUs in a reordering buffer. The determining unit 1020 is configured to determine whether sequence numbers of one or more missing PDCP SDUs are smaller than the smaller one of the two maximum sequence numbers among PDCP SDUs received by the PDCP entity from two lower layer entities, respectively. The delivering unit 1030 is configured to deliver one or more PDCP SDUs having sequence numbers smaller than the sequence numbers of the missing PDCP SDUs and one or more PDCP SDUs having sequence numbers larger than and consecutive with the sequence numbers of the missing PDCP SDUs, as stored in the reordering buffer, to a higher layer entity of the PDCP entity when the sequence numbers of the missing PDCP SDUs are smaller than the smaller of the maximum sequence numbers.

Preferably, the determining unit 1020 can be configured to determine whether the sequence numbers of the missing PDCP SDUs are smaller than the smaller of the maximum sequence numbers in a descending order of the sequence numbers of the missing PDCP SDUs, wherein, once the sequence number of one of the missing PDCP SDUs is determined to be smaller than the smaller of the maximum sequence numbers, any determination as to whether the sequence numbers of the remaining missing PDCP SDUs are smaller than the smaller of the maximum sequence numbers is omitted.

Correspondingly to the method according to the second aspect of the present disclosure, a corresponding PDCP entity 1100 is also provided. FIG. 11 is a block diagram showing a structure of a PDCP entity 1100.

As shown, the PDCP entity 1100 includes a PDU processing unit 1110 and a delivering unit 1020. The PDU processing unit 1110 is configured to map one or more PDCP Protocol Data Units (PDUs) received out-of-order from a lower layer entity of the PDCP entity to one or more PDCP Service Data Units (SDUs) and store the PDCP SDUs in a reordering buffer. The delivering unit 1020 is configured to deliver one or more PDCP SDUs stored in the reordering buffer that have sequence numbers smaller than or equal to a smaller of maximum sequence numbers among PDCP SDUs received by the PDCP entity from two lower layer entities, respectively, and their subsequent, consecutive PDCP SDUs, to a higher layer entity of the PDCP entity.

Preferably, the delivering unit 1120 can be configured to: determine whether the sequence numbers of the PDCP SDUs stored in the reordering buffer are smaller than or equal to the smaller one of the two maximum sequence numbers in a descending order of the sequence numbers of the PDCP SDUs stored in the reordering buffer, wherein, once the sequence number of one of the PDCP SDUs is determined to be smaller than or equal to the smaller one of the two maximum sequence numbers, any determination as to whether the sequence numbers of the remaining PDCP SDUs are smaller than or equal to the smaller one of the two maximum sequence numbers is omitted and the remaining PDCP SDUs, the PDCP SDU having the sequence number determined to be smaller than or equal to the smaller one of the two maximum sequence numbers and its subsequent, consecutive PDCP SDUs are delivered to the higher layer entity of the PDCP entity.

Each of the above PDCP entities 1000 and 1100 can be implemented in a Master Cell Group (MCG) or a User Equipment (UE) and can further include: a variable storage unit configured to maintain and update two variables, MCG_PDCP_RX_SN and SCG_PDCP_RX_SN. MCG_PDCP_RX_SN indicates a maximum sequence number among PDCP SDUs received by the PDCP entity from an RLC entity in an MCG or from an RLC entity in a UE that corresponds to the RLC entity in the MCG, and SCG_PDCP_RX_SN indicates a maximum sequence number among PDCP SDUs received by the PDCP entity from an RLC entity in an SCG or from an RLC entity in a UE that corresponds to the RLC entity in the SCG. The variable storage unit can be further configured to maintain and update a variable Min_PDCP_RX_SN indicating the smaller of MCG_PDCP_RX_SN and SCG_PDCP_RX_SN.

In an embodiment, when the PDCP entity delivers the PDCP SDUs to the higher layer entity, the smaller of MCG_PDCP_RX_SN and SCG_PDCP_RX_SN is updated to a maximum sequence number among the PDCP SDUs delivered to the higher layer plus 1. In an alternative embodiment, the variable storage unit can be further configured to maintain and update a variable Next_PDCP_RX_SN indicating a maximum sequence number among the PDCP SDUs delivered to the higher layer plus 1. Each of the maintained variables can have an initial value of 0.

Correspondingly to the method according to the third aspect of the present disclosure, a corresponding PDCP entity 1200 is also provided. FIG. 12 is a block diagram showing a structure of a PDCP entity 1200.

As shown, the PDCP entity 1200 includes a SDU discarding unit 1210 and a PDCP control PDU transmitting unit 1220. The SDU discarding unit 1210 is configured to discard one or more PDCP Service Data Units (SDUs) each having an associated discard timer expired. The PDCP control PDU transmitting unit 1220 is configured to transmit to a PDCP entity at a receiving side a PDCP control Protocol Data Unit (PDU) indicating all or part of the expired PDCP SDUs.

The PDCP entity 1200 can be implemented in a Master Cell Group (MCG) or a User Equipment (UE) and can further include a variable storage unit configured to maintain and update two variables, MCG_PDCP_RX_SN and SCG_PDCP_RX_SN. MCG_PDCP_RX_SN indicates a maximum sequence number among PDCP SDUs that have been acknowledged, by the PDCP entity from an RLC entity in an MCG or from an RLC entity in a UE that corresponds to the RLC entity in the MCG, to be successfully transmitted, and SCG_PDCP_RX_SN indicates a maximum sequence number among PDCP SDUs that have been acknowledged, by the PDCP entity from an RLC entity in an SCG or from an RLC entity in a UE that corresponds to the RLC entity in the SCG, to be successfully transmitted. The variable storage unit can be further configured to maintain and update a variable Min_PDCP_RX_SN indicating the smaller of MCG_PDCP_RX_SN and SCG_PDCP_RX_SN. Each of the maintained variables can have an initial value of 0.

In the foregoing, the present disclosure has been described with reference to preferred embodiments thereof. It should be understood that various modifications, alternations and variants can be made by those skilled in the art without departing from the spirits and scope of the present disclosure. Therefore, the scope of the present disclosure is not limited to the above specific embodiments but shall be defined by the claims as attached.

1. A method performed by a Packet Data Convergence Protocol (PDCP) entity, comprising:
mapping one or more PDCP Protocol Data Units (PDUs) received from lower layer entities of the PDCP entity to one or more PDCP Service Data Units (SDUs) and storing the PDCP SDUs in a reordering buffer;
determining whether sequence numbers of one or more missing PDCP SDUs are smaller than the smaller one of the two maximum sequence numbers among PDCP SDUs received by the PDCP entity from two lower layer entities, respectively; and
delivering one or more PDCP SDUs having sequence numbers smaller than the sequence numbers of the missing PDCP SDUs and one or more PDCP SDUs having sequence numbers larger than and consecutive with the sequence numbers of the missing PDCP SDUs, as stored in the reordering buffer, to a higher layer entity of the PDCP entity when the sequence numbers of the missing PDCP SDUs are smaller than the smaller of the maximum sequence numbers.

2-3. (canceled)

4. The method of claim 1, wherein the PDCP entity maintains and updates two variables, MCG_PDCP_RXSN and SCG_PDCP_RX_SN, MCG_PDCP_RX_SN indicating a maximum sequence number among PDCP SDUs received by the PDCP entity from an RLC entity in an MCG or from an RLC entity in a UE that corresponds to the RLC entity in the MCG, and SCG_PDCP_RX_SN indicating a maximum sequence number among PDCP SDUs received by the PDCP entity from an RLC entity in an SCG or from an RLC entity in a UE that corresponds to the RLC entity in the SCG.

5. The method of claim 4, wherein, when the PDCP entity delivers the PDCP SDUs to the higher layer entity, the smaller of MCG_PDCP_RX_SN and SCG_PDCP_RX_SN is updated to a maximum sequence number among the PDCP SDUs delivered to the higher layer plus 1.

6. The method of claim 4, wherein the PDCP entity further maintains and updates a variable Next_PDCP_RX_SN indicating a maximum sequence number among the PDCP SDUs delivered to the higher layer plus 1.

7. The method of claim 4, wherein the PDCP entity further maintains and updates a variable Min_PDCP_RX_SN indicating the smaller of MCG_PDCP_RX_SN and SCG_PDCP_RX_SN.

8. (canceled)

9. A Packet Data Convergence Protocol (PDCP) entity, comprising:
a PDU processing unit configured to map one or more PDCP Protocol Data Units (PDUs) received out-of-order from a lower layer entity of the PDCP entity to one or more PDCP Service Data Units (SDUs) and store the PDCP SDUs in a reordering buffer;
a determining unit configured to determine whether sequence numbers of one or more missing PDCP SDUs are smaller than a smaller one of maximum sequence numbers among PDCP SDUs received by the PDCP entity from two lower layer entities, respectively; and
a delivering unit configured to deliver one or more PDCP SDUs having sequence numbers smaller than the sequence numbers of the missing PDCP SDUs and one or more PDCP SDUs having sequence numbers larger than and consecutive with the sequence numbers of the missing PDCP SDUs, as stored in the reordering buffer, to a higher layer entity of the PDCP entity when the sequence numbers of the missing PDCP SDUs are smaller than the smaller of the maximum sequence numbers.

10-11. (canceled)

12. The entity of claim 9, further comprising:
a variable storage unit configured to maintain and update two variables, MCG_PDCP_RX_SN and SCG_PDCP_RX_SN, MCG_PDCP_RX_SN indicating a maximum sequence number among PDCP SDUs received by the PDCP entity from an RLC entity in an MCG or from an RLC entity in a UE that corresponds to the RLC entity in the MCG, and SCG_PDCP_RX_SN indicating a maximum sequence number among PDCP SDUs received by the PDCP entity from an RLC entity in an SCG or from an RLC entity in a UE that corresponds to the RLC entity in the SCG.

13. The entity of claim 12, wherein, when the PDCP entity delivers the PDCP SDUs to the higher layer entity, the smaller of MCG_PDCP_RX_SN and SCG_PDCP_RX_SN is updated to a maximum sequence number among the PDCP SDUs delivered to the higher layer plus 1.

14. The entity of claim 12, wherein the variable storage unit is further configured to maintain and update a variable Next_PDCP_RX_SN indicating a maximum sequence number among the PDCP SDUs delivered to the higher layer plus 1.

15. The entity of claim 12, wherein the variable storage unit is further configured to maintain and update a variable Min_PDCP_RX_SN indicating the smaller of MCG_PDCP_RX_SN and SCG_PDCP_RX_SN.

16. (canceled)

17. A method performed by a Packet Data Convergence Protocol (PDCP) entity, comprising:
mapping one or more PDCP Protocol Data Units (PDUs) received out-of-order from a lower layer entity of the PDCP entity to one or more PDCP Service Data Units (SDUs) and storing the PDCP SDUs in a reordering buffer; and
delivering one or more PDCP SDUs stored in the reordering buffer that have sequence numbers smaller than or equal to a smaller one of the two maximum sequence numbers among PDCP SDUs received by the PDCP entity from two lower layer entities, respectively, and their subsequent, consecutive PDCP SDUs, to a higher layer entity of the PDCP entity.

18. The method of claim 17, wherein said delivering one or more PDCP SDUs stored in the reordering buffer that have sequence numbers smaller than or equal to the smaller one of the two maximum sequence numbers among PDCP SDUs received by the PDCP entity from two lower layer entities, respectively, and their subsequent, consecutive PDCP SDUs, to the higher layer entity of the PDCP entity comprises: determining whether the sequence numbers of the PDCP SDUs stored in the reordering buffer are smaller than or equal to the smaller one of the two maximum sequence numbers in a descending order of the sequence numbers of the PDCP SDUs stored in the reordering buffer, wherein, once the sequence number of one of the PDCP SDUs is determined to be smaller than or equal to the smaller one of the two maximum sequence numbers, any determination as to whether the sequence numbers of the remaining PDCP SDUs are smaller than or equal to the smaller one of the two maximum sequence numbers is omitted and the remaining PDCP SDUs, the PDCP SDU having the sequence number determined to be smaller than or equal to the smaller one of the two maximum sequence numbers and its subsequent, consecutive PDCP SDUs are delivered to the higher layer entity of the PDCP entity.

19. (canceled)

20. The method of claim 17, wherein the PDCP entity maintains and updates two variables, MCG_PDCP_RX_SN and SCG_PDCP_RX_SN, MCG_PDCP_RX_SN indicating a maximum sequence number among PDCP SDUs received by the PDCP entity from an RLC entity in an MCG or from an RLC entity in a UE that corresponds to the RLC entity in the MCG, and SCG_PDCP_RX_SN indicating a maximum sequence number among PDCP SDUs received by the PDCP entity from an RLC entity in an SCG or from an RLC entity in a UE that corresponds to the RLC entity in the SCG.

21. The method of claim 20, wherein, when the PDCP entity delivers the PDCP SDUs to the higher layer entity, the smaller of MCG_PDCP_RXSN and SCG_PDCP_RX_SN is updated to a maximum sequence number among the PDCP SDUs delivered to the higher layer plus 1.

22. (canceled)

23. The method of claim 17, wherein the PDCP entity further maintains and updates a variable Min_PDCP_RX_SN indicating the smaller of MCG_PDCP_RX_SN and SCG_PDCP_RX_SN.

24. (canceled)

25. A Packet Data Convergence Protocol (PDCP) entity, comprising:
a PDU processing unit configured to map one or more PDCP Protocol Data Units (PDUs) received out-of-order from a lower layer entity of the PDCP entity to one or more PDCP Service Data Units (SDUs) and store the PDCP SDUs in a reordering buffer; and
a delivering unit configured to deliver one or more PDCP SDUs stored in the reordering buffer that have sequence numbers smaller than or equal to a smaller of maximum sequence numbers among PDCP SDUs received by the PDCP entity from two lower layer entities, respectively, and their subsequent, consecutive PDCP SDUs, to a higher layer entity of the PDCP entity.

26-27. (canceled)

28. The entity of claim 25, further comprising:
a variable storage unit configured to maintain and update two variables, MCG_PDCP_RX_SN and SCG_PDCP_RX_SN, MCG_PDCP_RX_SN indicating a maximum sequence number among PDCP SDUs received by the PDCP entity from an RLC entity in an MCG or from an RLC entity in a UE that corresponds to the RLC entity in the MCG, and SCG_PDCP_RX_SN indicating a maximum sequence number among PDCP SDUs received by the PDCP entity from an RLC entity in an SCG or from an RLC entity in a UE that corresponds to the RLC entity in the SCG.

29. The entity of claim 28, wherein, when the PDCP entity delivers the PDCP SDUs to the higher layer entity, the smaller of MCG_PDCP_RX_SN and SCG_PDCP_RX_SN is updated to a maximum sequence number among the PDCP SDUs delivered to the higher layer plus 1.

30. The entity of claim 28, wherein the variable storage unit is further configured to maintain and update a variable Next_PDCP_RX_SN indicating a maximum sequence number among the PDCP SDUs delivered to the higher layer plus 1.

31. The entity of claim 28, wherein the variable storage unit is further configured to maintain and update a variable Min_PDCP_RX_SN indicating the smaller of MCG_PDCP_RX_SN and SCG_PDCP_RX_SN.

32-45. (canceled)
